(19) United States
(12) Patent Application Publication
(10) Pub. No.: US 2017/0002910 A1
(43) Pub. Date: Jan. 5, 2017

(54) Positive Differential Lock

(71) Applicant: Daniel Kunau, Boone, CO (US)

(72) Inventor: Daniel Kunau, Boone, CO (US)

(21) Appl. No.: 14/862,062

(22) Filed: Sep. 22, 2015

Related U.S. Application Data
(60) Provisional application No. 62/053,329, filed on Sep. 22, 2014.

(51) Int. Cl. F16H 48/28; F16H 48/38; F16H 48/08

(52) U.S. Cl. CPC F16H 48/28; F16H 48/08; F16H 48/38; F16H 2048/382

(57) ABSTRACT

Methods and systems are provided for making and using a differential locking gear for locking a differential gear assembly that a first side gear connected to a first axel and a second side gear connected to a second axel. The differential locking gear has a first side with teeth configured to simultaneously mesh with first side gear teeth of the first side gear. The differential locking gear also has a second side with teeth configured to simultaneously mesh with second side gear teeth of the second side gear. The teeth of the differential locking gear that simultaneously mesh with the first and second side gears causes the first and second side gears to rotate in unison, thus locking the differential gear assembly.

### CROSS-REFERENCE TO RELATED APPLICATION

This application is a continuation application of and claims priority from provisional U.S. patent application Ser. No. 62/053,329 filed on Sep. 22, 2014.

### BACKGROUND

1. Field of the Invention

The present invention relates to gears for vehicular and industrial use, and more specifically to systems and methods of making and using a differential gear lock.

2. Description of Related Art

A differential gear assembly allows the left and right wheels to turn at different rotational speeds, while continuing to transfer power to both wheels. This is useful, for example, when turning corners. FIG. 1A depicts a pair of wheels on an axel assembly making a left turn. As depicted in the figure wheel R travels further than wheel L as the vehicle is turning. If the wheels were bound tightly to a single axel so as to have the same rotation, the tires would screech when turning a corner since one wheel would be traveling further than the other. The differential gear assembly that nearly all automobiles are equipped with allows right wheel R in FIG. 1A to turn at a slightly faster rate than left wheel L, thus maintaining traction throughout the turn.

FIG. 1B depicts a conventional differential gear assembly 100. Power from the engine is transferred to the differential gear assembly 100 by a drive axel 101. A pinion gear 105 connected to the end of drive axel 101 meshes with a ring gear 111. The ring gear 111 has spider gear mount 121 associated with it. By associated with it, it is meant that the spider gear mount 121 is either a separate part affixed to ring gear 111 or configured as part of it. The spider gear mount 121 has a spider gear pin 119 (sometimes called a cross shaft pin) which holds the spider gear 117. As the ring gear 111 rotates in direction 199, the spider gear mount 121 and also the spider gear 117 attached to it, rotates in the same rotational direction 199.

The spider gear 117 meshes with side gears 107 and 109, which are respectively connected to axels 113 and 115. If the vehicle is traveling in a straight line, the spider gear 117 causes both axels 113 and 115. However, the beauty of the differential gear assembly is that the spider gear 117 is free to rotate about the axis defined by spider gear pin 119. Thus, if the vehicle is turning a corner one of the axels can rotate slightly faster than the other, causing the spider gear 117 to rotate about the axis of pin 119 at the same time it is rotating along with ring gear 111 in the direction 199. One drawback of the conventional differential gear assembly 100 is that when one of the wheels loses traction the drive axel 103 does not impart any force to the other axel. Instead, the wheel that has lost traction simply spins while the other wheel remains motionless.

### SUMMARY

Various embodiments provide an apparatus for, and methods of making and using, a differential locking gear for locking the side gears of a differential gear assembly together. Typically, the two side gears of the differential gear assembly are connected to two parallel axels which in turn have wheels on them. In various embodiments the differential locking gear has several locking gear teeth on one side configured to simultaneously mesh with side gear teeth of the one side gear, and also has several locking gear teeth on another side configured to simultaneously mesh with side gear teeth of the other side gear. In various embodiments the differential locking gear is attached to a ring gear of the differential gear assembly using one or more pins, or bolts, that fit into one or more corresponding spider gear mounts of the differential gear assembly.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1A illustrates the difference in the length traveled by each of a pair of wheels making a turn;

FIG. 1B depicts a conventional differential gear assembly 100;

FIGS. 2A-B depict a multitooth meshing differential locking gear 241 in accordance with various embodiments disclosed herein; and

FIG. 3A provides a top view and FIG. 3B provides further views of various embodiments of the multitooth meshing differential locking gear.

FIG. 4 is a flow chart for making various embodiments of the multitooth meshing differential locking gear.

### DETAILED DESCRIPTION

There are times when it is desirable to be able to lock the differential gear assembly in place. For example, in slippery conditions when it is anticipated that one or the other of the wheels will lose traction it is advantageous to have the rear axels and rear wheels locked together in rotational motion. The present inventor recognized a problem with conventional ways of locking the differential. One such way is to welds the spider gear to the ring gear. This, however, is a brute force way of locking down the differential gear assembly that destroys the spider gear and ring gear. What is needed is a new way of locking the differential. Embodiments disclosed herein address drawbacks of the conventional methods, providing a new way of locking the differential gear assembly.

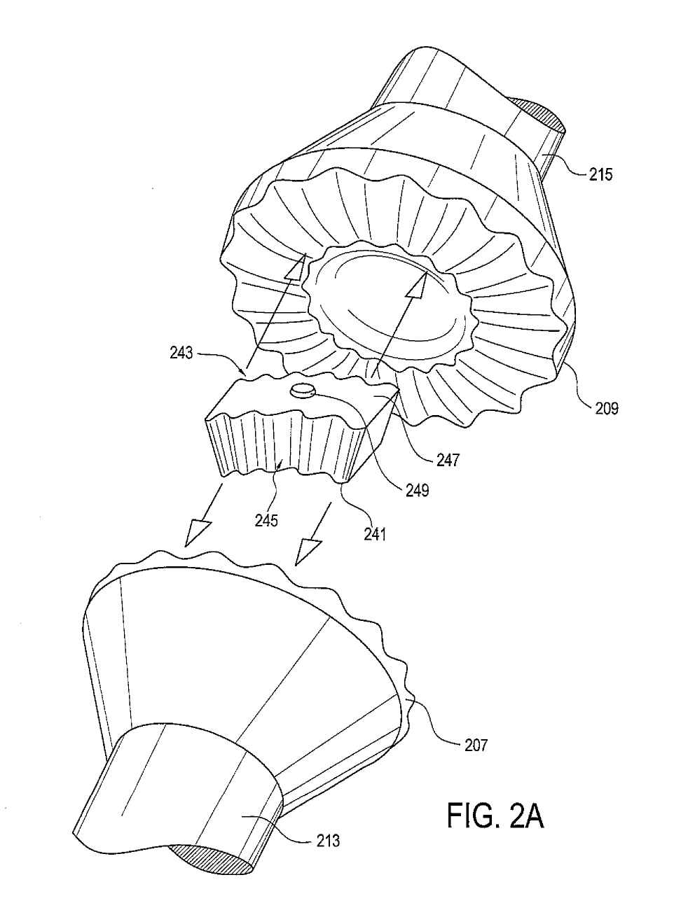

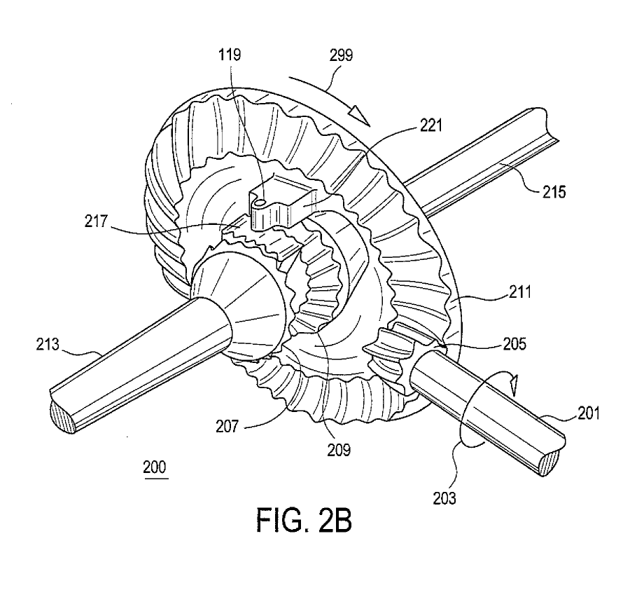

FIGS. 2A-B depict a multitooth meshing differential locking gear 241 (sometimes called a rectangular locking gear) in accordance with various embodiments disclosed herein. The multitooth meshing differential locking gear 241 takes the place of a conventional spider gear 117. As a conventional spider gear 117 rotates about the spider gear pin 119 a pair of spider gear teeth mesh with a single side gear tooth of the side gear 109 (or side gear 107). As the conventional spider gear 117 rotates a bit further about the spider gear pin 119 the next side gear tooth comes into play causing two side gear teeth to mesh with a single spider gear tooth. And so it goes, one spider tooth meshing with two side gear teeth, and then one side gear tooth meshing with two spider teeth.

The teeth of the multitooth meshing differential locking gear 241 mate with the teeth of the side gears 209 in a male-female manner, with the teeth of one fitting in the grooves of the other, and vice versa. Since the teeth and grooves of the side gears 207-209 are splayed outward—that is, the grooves and ridges tend to radiate out from the center—the teeth of grooves of the multitooth meshing differential locking gear 241 are also configured to splay outward in a manner configured to mesh the two parts with a minimum of rattling or play between the parts.

Various embodiments disclosed herein operate by having multiple teeth of the multitooth meshing differential locking gear 241 simultaneously mesh with multiple teeth of the side gears 207 and 209. This prevents the side gears 207 and 209, and corresponding axels 213-215, from rotating independent of each other. In other words, the side gears 207-209 and axels 213-215 are free to rotate, but must rotate at the same rate. At minimum two teeth of the multitooth meshing differential locking gear 241 must simultaneously mesh with at least two teeth of one of the side gears 207 and 209 (the other of side gears 207 and 209 could theoretically have only one tooth meshing with two teeth). For example, at minimum the multitooth meshing differential locking gear 241 could have two teeth on side 243 meshing with the side gear teeth of side gear 209 while one tooth of multitooth meshing differential locking gear 241 could have two teeth on side 245 meshes with two side gear teeth of side gear 207. In various embodiments, however, the multitooth meshing differential locking gear 241 is configured so that several locking gear teeth from each of sides 243 and 245 mesh with several teeth of each respective side gear 207 and 209.

The face 247 of the multitooth meshing differential locking gear 241 may have a hole 249 through which a pin may be inserted to attach the locking gear 241 to a spider gear mount. In some embodiments the multitooth meshing differential locking gear 241 may have multiple holes that allow it to be attached to multiple spider gear mounts. In various embodiments the face 247 is planar, while in other embodiments the face 247 is curved in an arc about the axis of rotation of the axels 213 and 215.

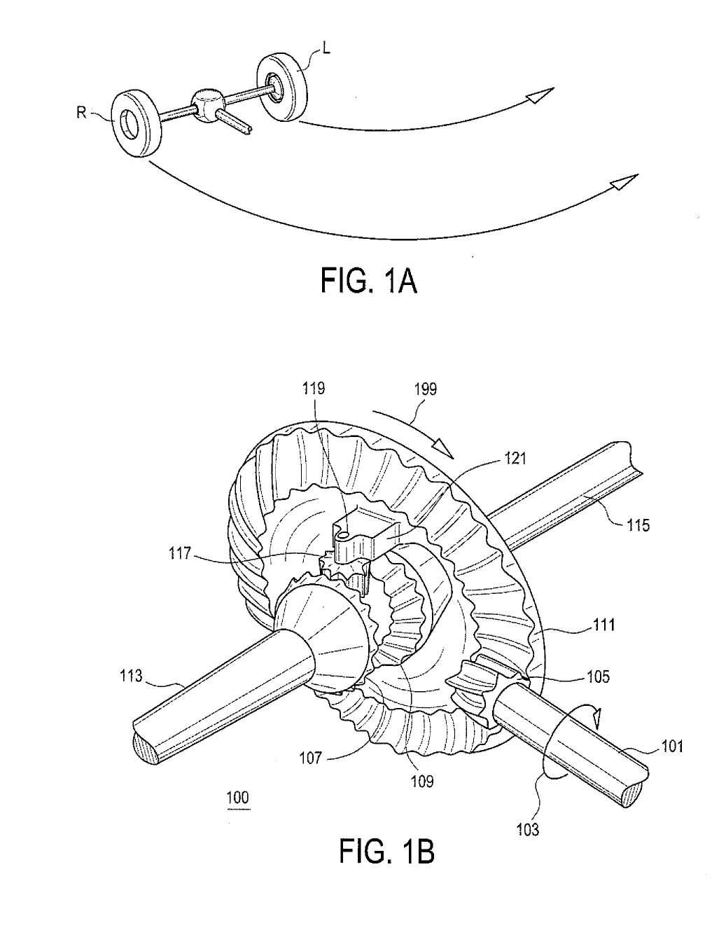

Typically, the multitooth meshing differential locking gear 241 is affixed to the ring gear with a pin such as the spider gear pin 119 of FIG. 1B. Some conventional differential gear assemblies have multiple spider gears, e.g., two spider gears or four spider gears. In such conventional designs each spider gear is attached to a spider gear mount with its own associated spider gear pin. In some of the various embodiments disclosed herein the multitooth meshing differential locking gear 241 is affixed to the ring gear using two or more spider gear pins and their associated spider gear mounts. For example, in one embodiment the multitooth meshing differential locking gear 241 may be attached to the ring gear 211 by two or more spinder gear pins and their associated spider gear mounts. This provides increased strength and stability in the positive differential lock mechanism.

Alternatively, the multitooth meshing differential locking gear 241 may be attached directly to the ring gear 211 by bolts, pins, welding, clamping or other like means of mechanical attachment.

Some embodiments disclosed herein have nonconsecutive teeth of the multitooth meshing differential locking gear 241 that simultaneously mesh with multiple teeth of the side gears 207 and 209. That is, unlike a conventional spider gear in which consecutive teeth rotate in to mesh with consecutive teeth of the side gears, the teeth of the multitooth meshing differential locking gear 241 that simultaneously mesh need not be consecutive.

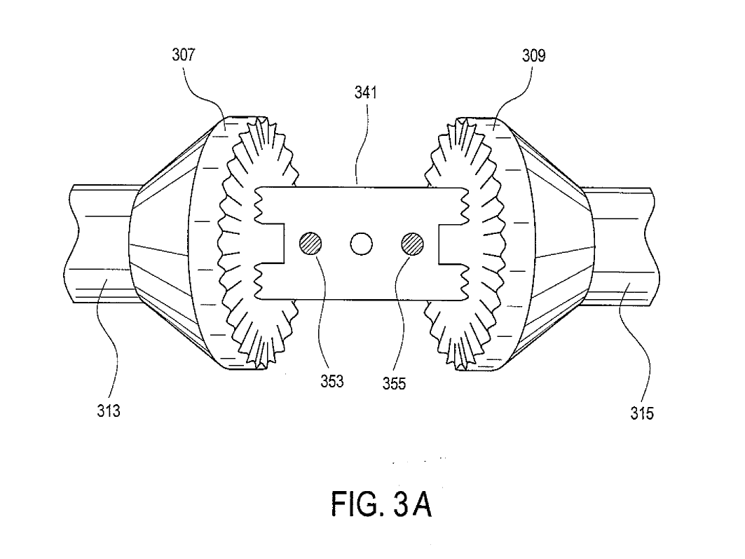

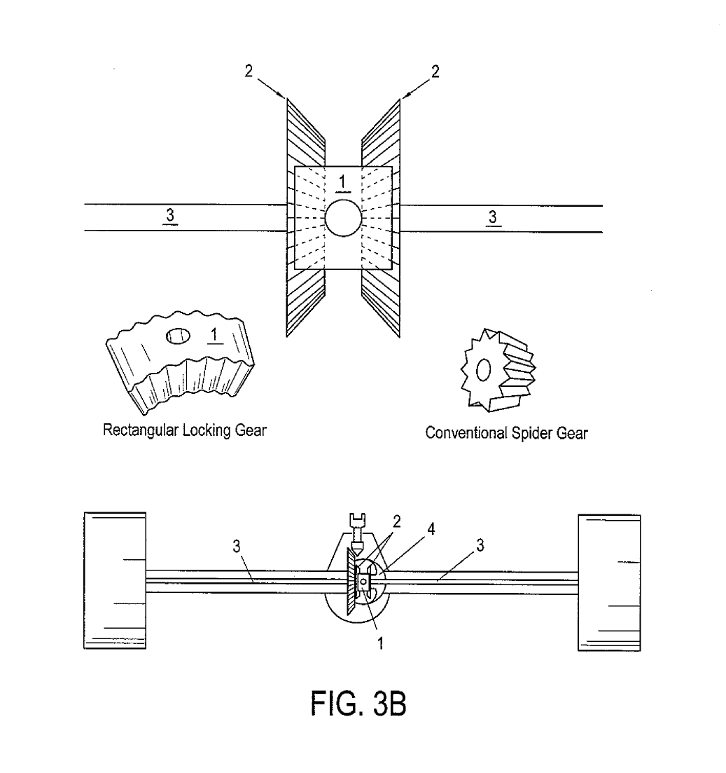

FIG. 3A provides a top view and FIG. 3B provides further views of various embodiments of the multitooth meshing differential differential locking gear 341. These views illustrate the simultaneous meshing of the locking gear teeth of the multitooth meshing differential locking gear 341 with the side gear teeth of side gears 307 and 309. Since multiple teeth mesh at the same time the side gears 307-309, and associated axels 313-315 are bound together with the multitooth meshing differential locking gear 341 so that all the parts rotate at the same rate and amount as the multitooth meshing differential locking gear 341 is driven around by virtue of its connection to the ring gear. In this embodiment each side of the multitooth meshing differential locking gear 341 is depicted with a gap in its teeth, demonstrating the embodiment in which nonconsecutive teeth are used to mesh with the side gear teeth.

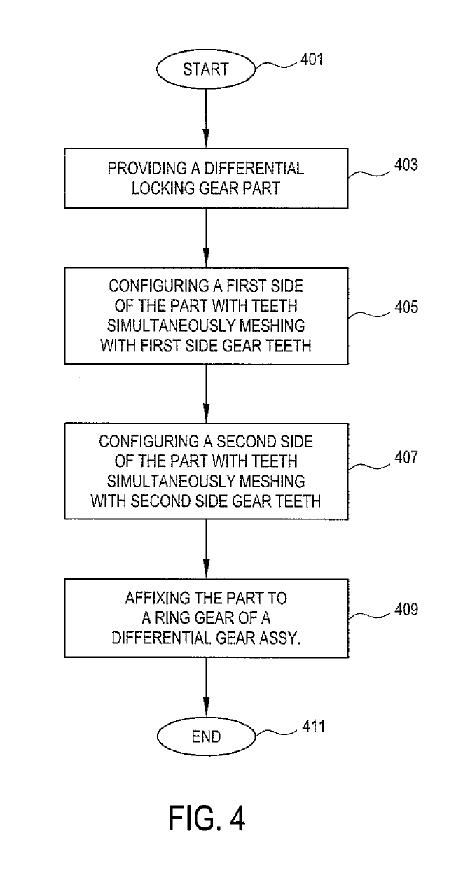

FIG. 4 is a flowchart depicting the use of the concrete screed 100 according to various embodiments of the invention. The method begins in block 401 and proceeds to block 403 to provide a differential locking gear part for locking a differential gear assembly with two side gears that are respectively connected to two axels—a first axel and a second axel. Upon completing block 403 the method proceeds to block 405.

In block 405 the first side of the differential locking gear is configured to have multiple locking gear teeth that simultaneously mesh with first side gear teeth of the first side gear. The method then proceeds to block 407 where the second side of the differential locking gear is also configured to have multiple locking gear teeth that simultaneously mesh with second side gear teeth of the second side gear. Once the teeth of the differential locking gear are configured the method proceeds to block 409.

In block 409 the differential locking gear is attached to a ring gear of the differential gear assembly. This may be done using one or more pins that insert into corresponding one or more spider gear mounts of the ring gear. In other embodiments the differential locking gear may be attached to a ring gear using bolts or other like mechanical means of attaching parts. Upon attaching the differential locking gear to the ring gear the method proceeds to block 411 and ends.

The description of the various embodiments provided above is illustrative in nature inasmuch as it is not intended to limit the invention, its application, or uses. Thus, variations that do not depart from the intents or purposes of the invention are intended to be encompassed by the various embodiments of the present invention. Such variations are not to be regarded as a departure from the intended scope of the present invention.

What is claimed is:

1. A differential locking gear for locking a differential gear assembly comprising a first side gear connected to a first axel and a second side gear connected to a second axel, the differential locking gear comprising:
a first side with first plurality of locking gear teeth configured to simultaneously mesh with first side gear teeth of the first side gear;
a second side with second plurality of locking gear teeth configured to simultaneously mesh with second side gear teeth of the second side gear;
means for attaching the differential locking gear to a ring gear of the differential gear assembly;
wherein the first plurality of the locking gear teeth simultaneously meshed with the first side gear teeth and the second plurality of the locking gear teeth simultaneously meshed with the second side gear teeth causes the first axel to rotate in unison with the second axel about an axis.

2. The differential locking gear of claim 1, wherein the first axel and the second axel are both aligned with said axis;
wherein the first plurality of the locking gear teeth are configured to be splayed out from a first point on said axis; and
where the second plurality of the locking gear teeth are configured to be splayed out from a second point on said axis.

3. The differential locking gear of claim 1, wherein said means for attaching the differential locking gear to the ring gear of the differential gear assembly comprises:
a first pin configured to fit within a first spider gear mount associated with the ring gear.

4. The differential locking gear of claim 3, wherein said means for attaching the differential locking gear to the ring gear of the differential gear assembly comprises:
a second pin configured to fit within a second spider gear mount associated with the ring gear.

5. The differential locking gear of claim 3, wherein the first plurality of the locking gear teeth that simultaneously meshed with the first side gear teeth include nonconsecutive ones of the locking gear teeth defining a gap; and
where no teeth of the differential locking gear mesh with teeth of the side gear beneath the gap.

6. The differential locking gear of claim 1, wherein a face of the differential locking gear opposite the axis is planar.

7. A method of making a differential locking gear for locking a differential gear assembly comprising a first side gear connected to a first axel and a second side gear connected to a second axel, the method comprising:
providing a first side of the differential locking gear with first plurality of locking gear teeth configured to simultaneously mesh with first side gear teeth of the first side gear;
providing a second side of the differential locking gear with second plurality of locking gear teeth configured to simultaneously mesh with second side gear teeth of the second side gear; and
attaching the differential locking gear to a ring gear of the differential gear assembly;
wherein the first plurality of the locking gear teeth simultaneously meshed with the first side gear teeth and the second plurality of the locking gear teeth simultaneously meshed with the second side gear teeth causes the first axel to rotate in unison with the second axel about an axis.

8. The method of claim 7, wherein the first axel and the second axel are both aligned with said axis;
wherein the first plurality of the locking gear teeth are configured to be splayed out from a first point on said axis; and
where the second plurality of the locking gear teeth are configured to be splayed out from a second point on said axis.

9. The method of claim 7, wherein the attaching of the differential locking gear to the ring gear of the differential gear assembly comprises:
providing a first pin configured to fit within a first spider gear mount associated with the ring gear.

10. The method of claim 9, wherein the attaching of the differential locking gear to the ring gear of the differential gear assembly comprises:
providing a second pin configured to fit within a second spider gear mount associated with the ring gear.

11. The method of claim 9, wherein the first plurality of the locking gear teeth that simultaneously meshed with the first side gear teeth include nonconsecutive ones of the locking gear teeth defining a gap; and
where no teeth of the differential locking gear mesh with teeth of the side gear beneath the gap.

12. The method of claim 7, wherein a face of the differential locking gear opposite the axis is planar.
